(19) United States
(12) Patent Application Publication
(10) Pub. No.: US 2008/0010598 A1
(43) Pub. Date: Jan. 10, 2008

(54) Dedicated computer client application for searching an online dating database

(75) Inventors: Abe Smilowitz, Miami Beach, FL (US); Ernesto Morales, Miami Beach, FL (US); Robert Garner, Miami Beach, FL (US); Michael Hankey, Miami Beach, FL (US)

Correspondence Address: FLEIT KAIN GIBBONS GUTMAN BONGINI & BLANCO, PL, 21355 E. DIXIE HIGHWAY, SUITE 115, AVENTURA, FL, 33180, US

(73) Assignee: Webdate, Inc.

(21) Appl. No.: 11/483,441

(22) Filed: Jul. 10, 2006

(51) Int. Cl. G06F 7/00

(52) U.S. Cl. 715/745; 707/102

(57) ABSTRACT

A dedicated computer client application interfaces with, searches, and displays results from an online dating database. The application opens a window on the computer desktop. Search criteria entered into the application and matching profiles from the database are displayed in the window. Profiles can be selected to form matches with other members. Tools to facilitate communication between users are included. The application consumes a portion of the computer desktop and includes autoscrolling to allow a user to passively browse the window while working in other windows on the computer desktop.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to online dating services and computer applications for accessing them.

2. Description of the Related Art

Matchmaking is an ancient art. From the family friend to a commercial enterprise, dating services have evolved. In attempts to satisfy their customers, dating services have applied various strategies and technology in attempts to produce successful compatible couples.

Dating services have harnessed the technology, networking, and community of the Internet. A typical online dating service keeps a database of member profiles. Member profiles include various fields of data that the online dating service believes will be useful for successfully forming compatible couples. The data kept in profiles typically includes a member's gender, the gender being sought, physical characteristics of the member, interests of the member, photographs of the member, and other relevant data.

With their member profiles stored in their database, dating services employ various methods of matching members to each other. Members enter criteria for searching the database and matches result. Dating services employ various statistical tools and fuzzy logic to include near matches and to rank the quality of the match.

As stated, a member typically begins to meet another member of the dating service by posting their profile and then by entering search criteria and searching the database of user profiles. The initial search results provide potential matches. The matches are “potential” because both the user and the member have not agreed to the match. From the potential matches, a user selects specific members by their profile who interest the user. A message (i.e. an invitation) is then relayed by the server to the given member. If the given member accepts the invitation, a match is created. Matches have the ability to communicate with each other by short messages, email, and online chat.

Methods of matching can be divided into two categories: one-way matching and two-way matching.

One-way matching involves a user providing criteria. The criteria are used to find matches from the database. The resulting matches are usually ranked from the most compatible to the least.

Two-way matching also involves users entering criteria for searching the database. However, in two-way matching, the match and ranking are based not only on the user's criteria but on the potential match's compatibility with the user as well.

Online dating databases typically employ computer servers to store the information in their database. In turn, the servers are connected to web servers. Users login, access, edit, and search the database through the web servers. Users use clients that connect via a network (usually the Internet) to send and receive information from the web servers and database. Clients can take the form of terminals, personal computers, mobile telephones, personal data assistants (PDAs), and the like.

The most common way for users to access most online dating services is with a personal computer using a web browser via an Internet connection. FIG. 7 shows a web browser viewing an online dating database. Web browsers have become powerful applications that can display most forms of data. Web browsers not only have the power to view websites, they can now view word-processing document spreadsheets, and all of the data made available on an intranet. As the power of web browsers has increased, so has their “footprint”: that is, the resources of the computer that are being consumed. Not only do web browsers consume system memory and processor time, they also consume desktop space. To provide a versatile interface that is useful for browsing the many types of media being browsed, web browsers include a universal set of buttons (i.e. forward, backward, refresh, search, etc.) that may not be needed when accessing specific forms of data. In addition, most browsers add various toolbars for searching, document generation, and shortcuts that consume even more desktop, processor, and memory space. Because the desktop space consumed by web browsers has grown, many users (especially those with smaller monitors) find it difficult to maintain an open browser on the same desktop on which they are simultaneously working with another application (for example, a word processor). As a result, users have been unable to simultaneously browse an online dating database while continuing to work in a different window on the same computer desktop.

U.S. Published Patent Application No. US 2005/0086211 (hereinafter “Mayer '211”) describes an instant message client that is an application running on a client computer. The user completes a profile on the client computer. The instant message application uploads the profile and receives matches from the server. Matches are placed on the contact list of the instant message application without the other member's permission. A beacon from the instant message client lets the server know if a user has become offline even though the user had not logged off properly. Mayer '211 does not specify that the potential matches are displayed in the application. Mayer '211 does not disclose a scrolling interface and does not disclose an icon hidden in the system tray when minimized. Mayer '211 does not teach an application that can be a window overlying other work but only consuming a portion of the desktop to allow other work to continue while passively browsing.

Zvinyastskovsky et al. '142 (and Weiss et al. '147 and other patents and applications) are owned by Yahoo! The described system includes client devices. The clients can receive instant messages and display information from the server. The client devices can run a web browser that allows the user to browse, email, and instant message. The client application also allows a user to edit search criterion while simultaneously updating matching results. The matches include photographs and additional profile information. The Yahoo! documents do not teach an application for passive browsing that enables a user to conduct other activities.

Collins '951 teaches a computerized on-line dating service for searching matching people and is owned by Match.com. The patent teaches to access the database with an internet browser. A dedicated application is not taught.

Accordingly, a need exists for a dedicated application that consumes less resources than a web browser to browse filtered, potentially-matching online dating profiles and that can be passively viewed while still allowing other work to be conducted on the computer desktop.

### BRIEF SUMMARY OF THE INVENTION

It is accordingly an object of the invention to provide a dedicated computer client application for searching an online dating database that overcomes the above-mentioned disadvantages of the heretofore-known devices and methods of this general type and that consumes a minimum of computer and desktop resources and that allows a user to passively browse profiles of potential matches while continuing to work using other applications on the computer desktop.

With the foregoing and other objects in view there is provided, in accordance with the invention, a dedicated computer client application for interfacing with an online dating database of profiles. The application creates a window that is displayed on a client computer desktop. The window covers only a portion of the computer desktop. A summary profile from the online dating database is displayed in the window. The summary profile is derived from a profile of a member in the online dating database and matches a criterion provided by the user. A button is disposed in the window and associated with the summary profile. The button invites the member to add the user to a match list of the member and the user. The application is “dedicated” in that it is configured to display data provided by the online dating database but is not a general browser that is intended to display information from other websites and servers.

The size of the window is less than one quarter of the total available desktop area. While percentages of desktop space changes with a user's preferences and the size of a user's monitor, applicants have found that a window size of no more than five centimeters (5 cm) tall and eighteen centimeters (18 cm) wide is preferable. Making the window too small prevents the user from quickly scanning the page and from being able to see enough information.

As stated, an object of the invention is to allow “passive” browsing of profiles. “Passive” is meant to mean that the user can view a changing list of profiles without intervening with the application. In addition, the term “passive” is meant to imply that a user can be conducted other activity while still passively using the application. For example, the user can be working in a word-processor window on the desktop while the application is running in a different space on the computer desktop.

A further object of the invention is to provide an application that provides a plurality of profiles at a given time. Preferably, five summary profiles are shown at a given time. Providing a number of profiles allow a user to glance at a number of summary profiles quickly. However, the number of profiles must be limited to a number, for example five, in order to prevent the user from being distracted and having to stop and scrutinize all of the summary profiles.

To further the ability of the application to promote passive browsing, the application can be set to autoscroll periodically. That is, after a period of time that is set by the user, the summary profile or profiles that are being displayed are replaced with different summary profiles that are potential matches. The application allows for the time period to be adjusted. In this way, a user can work in another application and glance once per period of time at the window of the application. The autoscroll can be turned off. In addition, users of the application can page forward and backward through profiles. In addition, users can enter a specific page to which they can browse directly.

The summary profiles being shown in the application can be potential matches. If the user notices a summary profile that interests the user, the user may select to send a message such as an invitation to the member associated with the profile. If the member accepts the invitation, then the user and the member become a match.

To further the object of allowing passive viewing of summary profiles, the window of the application can be set to remain on top of the desktop. That is, the window of the application remains viewable and unobstructed on the desktop even when other applications are selected. Because the window only consumes only a portion of the computer desktop, the other applications being overlapped are still viewable and usable.

In accordance with a further object of the invention, the application is an extensible markup language browser. The Extensible Markup Language (XML) is a W3C-recommended general-purpose markup language for creating special-purpose markup languages, capable of describing many different kinds of data. In other words, XML is a way of describing data and an XML file can contain the data too, as in a database. It is a simplified subset of Standard Generalized Markup Language (SGML). Its primary purpose is to facilitate the sharing of data across different systems, particularly systems connected via the Internet. Within the context of the invention, data in the form of XML is sent from the web server connected to the database. The data reaches the client computer by a network, preferably the Internet. The application then displays the data. The summary profile, which is in the form of XML, is formed from the (full) profile stored in the online dating database. The application, by being adopted to display this information and not adapted to provide other information such as html, consumes less computer resources such as memory and processor time than other browsers.

As a user views summary profiles and becomes curious about a summary profile, the user may want to learn more about a user's profile. By selecting the summary profile, the application opens a further window. In the further window, a detailed profile can be displayed. With the additional information in the detailed profile, the user can decide to make a match.

If a summary profile interest the user, the user can select an email button that is disposed in the window beside the respective summary profile. When the email button is selected, the application opens an email window. The email window allows the user to write an email letter. The email is forwarded to the member via the server. By using the server rather than the user's email program, the privacy of the user's email address is maintained.

A button for sending instant messages can be included in the window beside each profile. When pressed, the button sends an instant message to the member associated with the summary profile. In the online dating service context, the inventors refer to such instant messages as “flirts” and the button within the window that triggers a flirt as the “flirt button”. When selecting the flirt button, a window opens allowing a flirt message to be sent. The window can include fields to be completed by the user or the message can be selected from a list of prepared (i.e. canned) messages.

For each summary profile when the user is online, a respective chat button is placed in the window. The chat button opens a chat window. In the chat window, users can send text messages in real time, transmit and receive video and sound, and see each others profiles and pictures.

Summary profiles are expurgated versions of the detailed profiles stored in the online database. The summary profiles preferably include a thumbnail photograph of the member and other brief information such as the user's age and location. Summary profiles can be quickly scanned in the window as the user continues working on other applications in other windows. The user can scan the summary profiles that are displayed in the window. If a summary profile interests the user, the user can select the profile to open a window containing the member's detailed profile. In addition, the user can select one of the buttons such as the email button, flirt button, or chat button in order to communicate with the member.

To provide as much information in the window without consuming additional desktop area, the application provides pages within the window. Preferably, only one page is displayed at a given time. However, each page has a tab that is always visible. The tab of a page can be selected to move the respective page to the top of the window. Examples of pages that can be included in the window are the browse page, the flirts page, the email page, the search page, and the settings page.

The search page provides a means for entering criteria with which the database can be searched for potential matches. A search page is provided within the window of the application. The search page allows criteria matching fields in the database to be entered. Examples of fields that could be included in the database and searched from the application include the following: username, gender, gender being sought, age, city, state, country, hair color, eye color, body type, ethnicity, religion, occupation, education, income, drinking behavior, relationship status, have children, and if the member wants children. Once the user enters data in the application, the criteria are submitted to the web server and online database; potential matches are found and transmitted to the application where they are displayed.

The flirt page helps the user to organize incoming and outgoing flirts, which as stated before are instant messages. When an incoming flirt is received, the message is shown along with a summary profile of the sender. The user can select the summary profile to view a detailed profile of the sender. The user can then approve or decline or sender to form a match. Matches remain on each others flirt pages to facilitate communication.

An email page in the window organizes incoming and sent emails. The email page shows header information (i.e. sender, title, date sent, and whether the email was read or unread. A message on the email page can be selected to open an email window showing the full text of the movie. The email window has a reply button to allow the user to send a reply email to the sender. Emails on the email page can be filtered to show only the read or unread messages. Likewise, the sent email messages can be shown on the email page.

A search page is included in the window. The search page includes fields for the user to enter criteria. When a submit button is selected, the application transmits the criteria to the web server. Applications in the web server search the member profiles based on the user-supplied criteria. The applications convert member profiles into summary profiles, which are in turn transmitted to the application on the client application in the form of XML. While a variety of criteria are possible, the search page could include fields for entering criteria asking the user's gender, the gender being sought, the lowest and highest possible age of matches, and zip code where profiles are to be found. In searching, known methods involving fuzzy logic and match ranking can be used to expand the search and to order the search results. Matching profiles can be further filtered to include only profiles that include photographs or that are online.

A settings page is included in the window of the application. The settings page allow the user enter a username, a password field for entering a password, and a submit button. The submit button transmits the username and the password to the online dating database.

Additional settings of the application are controlled from the settings page. For example, a checkbox can be included to cause the application to be run every time at the workstation's startup. The settings page can have a show alerts checkbox. When show alerts is checked, the application displays pop-up alerts upon receipt of emails, instant messages, and flirt messages. Included in the pop-up alert, is a username, thumbnail, or summary profile of the sender. Selecting the pop-up letter opens the email, instant message, or flirt. The pop-up alert also has a close button to close the pop-up alert.

The application can also be set to open a bubble whenever a summary profile is hovered over. The bubble includes a more detailed profile than the summary profile. Bubbles allow a user to quickly see more information about a summary profile without having to open a new window.

Other features which are considered as characteristic for the invention are set forth in the appended claims.

Although the invention is illustrated and described herein as embodied in a dedicated computer client application for searching an online dating database, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a computer desktop with a window of an application according to the invention.

FIG. 2 shows the window of the application with a browse page being displayed.

FIG. 3 shows the window of the application with a flirts page being displayed.

FIG. 4 shows the window of the application with an email page being displayed.

FIG. 5 shows the window of the application with a search page being displayed.

FIG. 6 shows the window of the application with a settings page being displayed.

FIG. 7 shows a computer desktop with a web browser displaying a webpage of an online dating database according to the prior art.

FIG. 8 is a window showing a detailed profile window.

FIG. 9 shows a send flirt window.

FIG. 10 shows a chat window.

FIG. 11 shows an incoming email window.

FIG. 12 shows an outgoing email window.

FIG. 13 shows a popup alert.

FIG. 14 shows the window of the application with a sent email page on top.

FIG. 15 shows a sent email window.

FIG. 16 shows the window of the application with a flirt approval page on top.

FIG. 17 is a schematic drawing of a computer network according to the invention.

FIG. 18 shows the window of the application with the browse page on top and with a popup profile being shown.

### DETAILED DESCRIPTION OF THE INVENTION

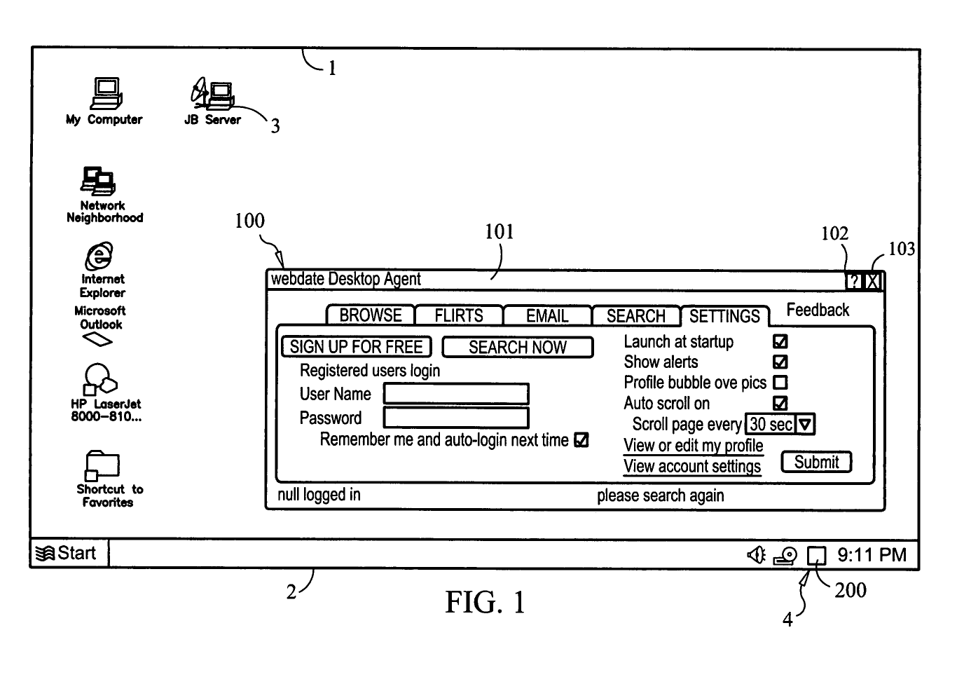

Referring now to the figures of the drawing in detail and first, particularly, to FIG. 1 thereof, there is seen a computer desktop 1, which is typical of computer operating systems with graphical user interfaces such as those sold under the trademark WINDOWS®. The computer desktop 1 includes a taskbar 2 for switching between applications that are running. A system tray 3 is located in the taskbar 2 by default at the bottom right of the computer desktop 1. The system tray 4 contains miniature icons 200 for easy access to system functions. Double clicking on a miniature icon 200 allows a view and access to details application settings and controls. Desktop shortcuts 3 are icons on the computer desktop 1 that can be double-clicked to launch associated applications and documents. In FIG. 1, the window 100 is not drawn to proportion with the computer desktop 1. As discussed below, to allow passive browsing, the window 100 is preferably much smaller on the computer desktop 1 than what is shown.

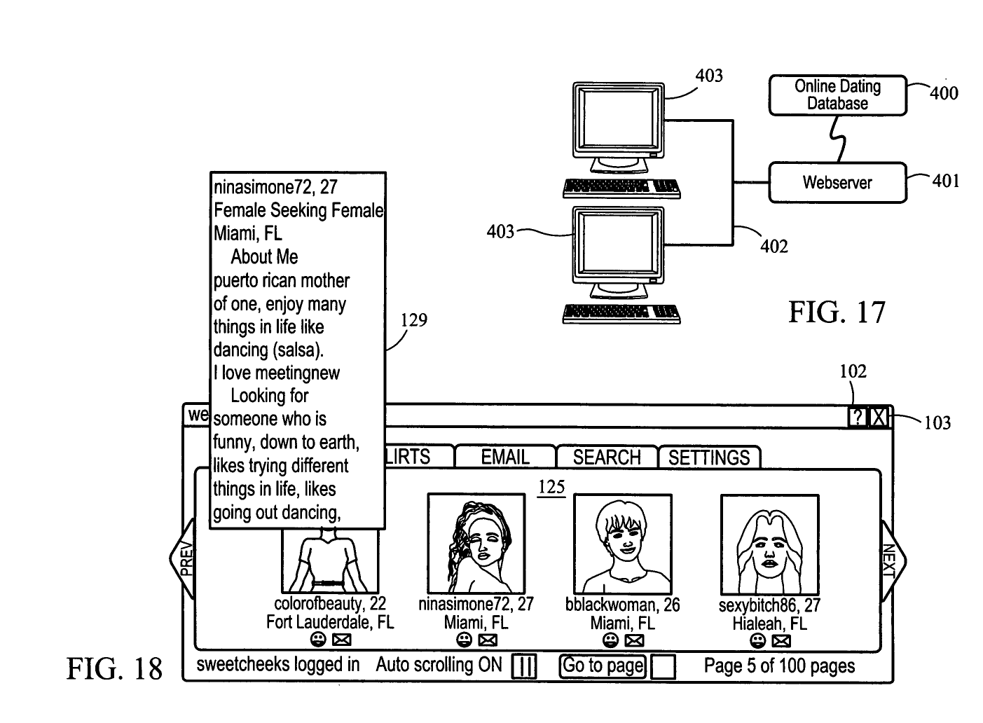

FIG. 17 shows a preferred embodiment of a network used in conjunction with the application according to the invention. An online dating database 400 is hosted on a computer server. The online dating database 400 is connected to a web server 401. The web server 401 receives incoming requests from clients and transmits data to clients 403. The web server 401 runs applications for maintaining and search the online dating database. The web server 401 is connected by a computer network, preferably the Internet, to client computers 403. The client computers 403 are running client software, most preferably, the WINDOWS operating system.

A window 100 of an application according to the invention is on the lower right of the computer desktop 1. The window 100 has a title bar 101. The title bar 101 displays a name of the application, i.e. WEBDATE DESKTOP AGENT. The title bar 101 includes a help button 102 and close button 103. The help button 102 provides a hyperlink to an html-based help file. The close button 103 closes the window 100. The application remains running even though the window 100 has been closed. Within the window 100, a number of pages 109, 125, 131, 141, 151, and 161 exist. Each page has a respective tab 110, 125, 130, 140, 150, and 160. The tabs are always visible within the window 100 and allow a respective page to be brought to the top of the window 100.

The size (i.e. area) of the window 100 in both relative (to the overall computer desktop 1) and absolute terms is a key feature of the invention. In the preferred embodiment, the area of the window consumes less than ten percent of the area of the computer desktop 1. In absolute terms, the window 100 is preferably thirteen centimeters (13 cm) wide and four and one half centimeters (4.5 cm) high.

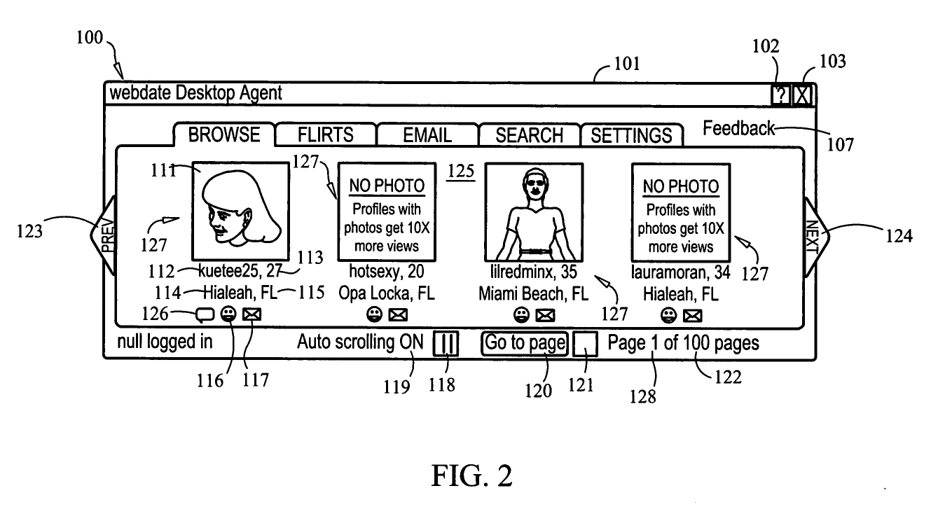

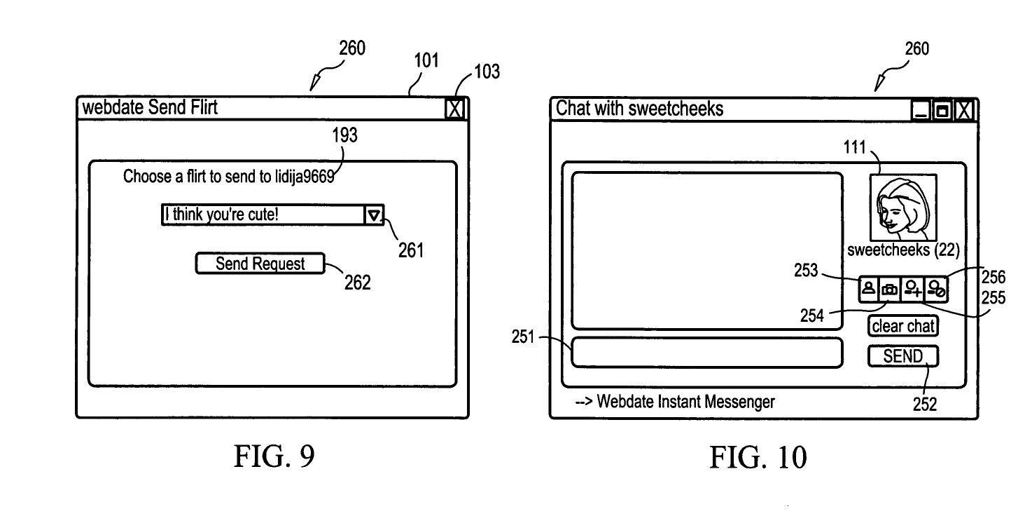

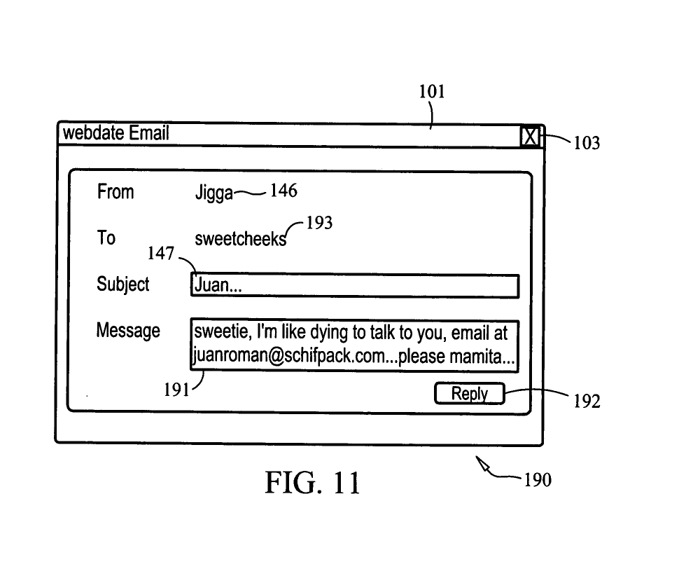

FIG. 2 shows a detailed view of the browse page 111 when the browse page 111 is on top within the window 100. The browse page 111 displays a plurality of summary profiles 127. Each summary profile 127 is a potential match based on criteria entered by the user and transmitted from the online dating database 400. Each summary profile 127 is transferred as data in the form of Extensible Markup Language (XML). Each summary profile 127 includes a thumbnail 111. The thumbnail 111 is a picture of the user whose summary profile 127 is being displayed. The thumbnail 111 can be selected to open a detailed profile window 300. The summary profile 127 also includes, for the user associated with the profile, a username 112, an age 113, a city 114, and a state 115. A flirt button 116 is included below each profile. When selected, the flirt button 116 sends a brief message to the user associated with the profile called a “flirt” by opening a flirt window 260 as shown in FIG. 9. Preferably, the brief message is selected from a group of pre-entered messages like, “I think you are cute,” “I think we could be friends,” etc. by using the flirt dropdown box 261 and then clicking the send button 262. An email button 117 associated with each summary profile 127 is also included on the browse page 125. When selected, the email button 117 opens an email window 190 as shown in FIG. 11. The email window 190 allows an email message to be composed. The email address of the recipient user is not displayed, only the username 193. The web server 401 receives the email message from the application, locates the recipient user's email address from the online dating database 400, and forwards the email message to the recipient user's email address. A chat button 126 is displayed beneath each summary profile 127 when the user associated with the summary profile 127 is online. When the chat button 126 is selected, a chat window 250 as shown in FIG. 10 opens. From the chat window 250, the user may enter text in a message field 251 and then select a send button 252 to send an instant message to the user associated with the respective summary profile 127. The browse page 125 includes an autoscroll switch 118. When the autoscroll switch is set to on, the summary profiles 127 that are currently displayed on the browse page 125 are periodically replaced with different summary profiles 127. The browse page 125 includes the current page number 128 taken out of a total page number 122. To go to a specific page, the user may enter a page number into the page field 121 and select the go to page button 120. The user may manually change the page to next page or the previous page by selecting the next page button 124 and the previous page button 123.

The chat window 250 includes a transcript field 257 to display incoming and outgoing messages. A thumbnail 111 of the member is included. A profile button 253 opens a detailed profile window 300. A webcam button 254 starts a user's webcam. An add member button 255 adds a member to the user's match list. A ban button 256 prevents future messages from being received from the member. A clear chat button 258 clears the transcript field 257.

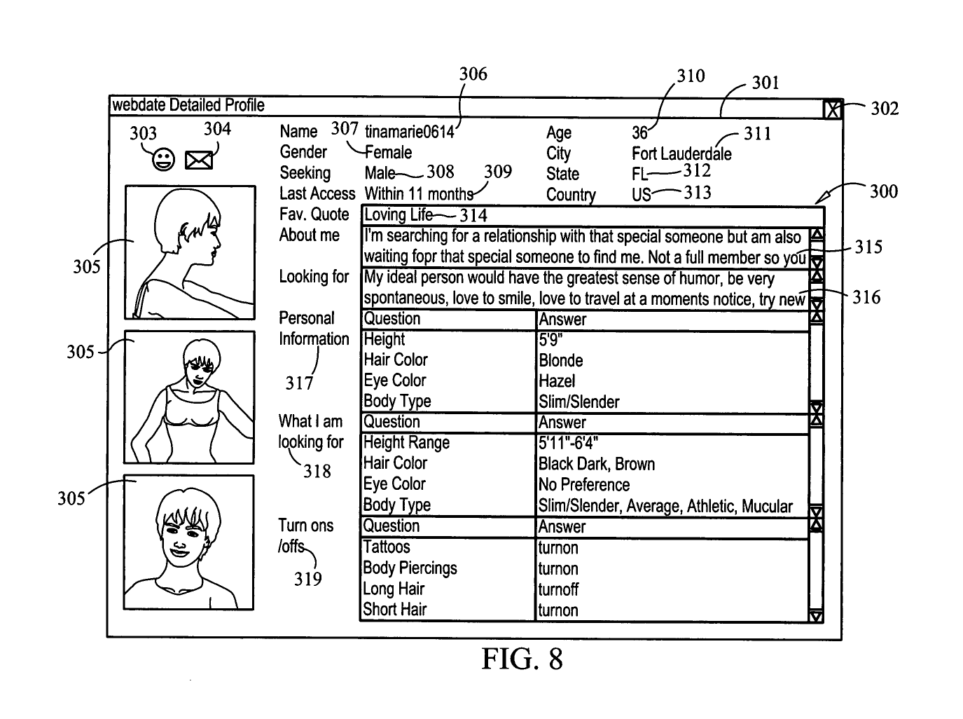

FIG. 8 shows a detailed profile window 300. The detailed profile window 300 lists the data stored in the online data database 400 that relates to a selected member.

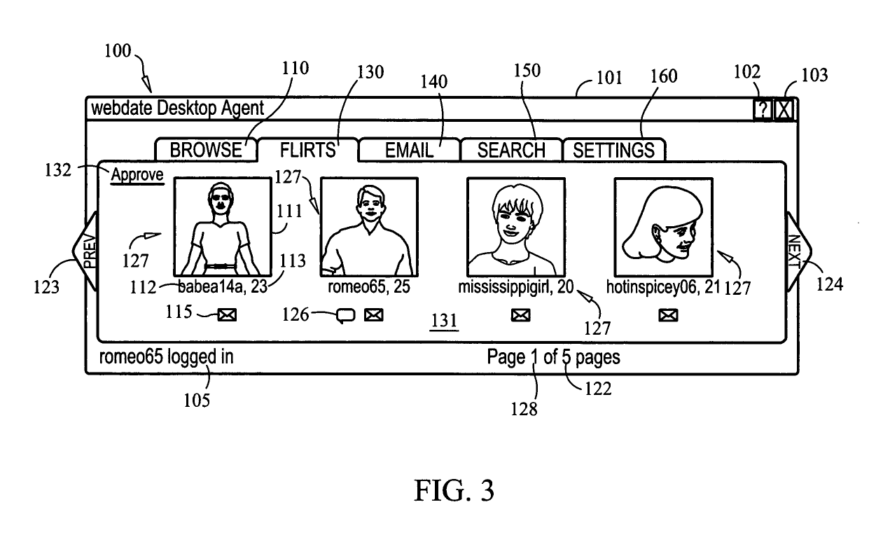

FIG. 3 shows the window 100 of the application when the flirts page 131 has been selected. The flirts page 131 shows summary profiles 127 who have accepted your flirt request or whose flirt requests have been approved by the user. The flirts page 131 also shows summary profiles 127 of users who have sent flirt requests and are pending approval. The summary profiles 127 each include a respective thumbnail 111, username 112, and age 113. An email button 15 beneath each summary profile 127 opens an email window 190 that allows the user to send an email to the user associated with the user profile. If the user associated with the summary profile 127 is online, a chat button 126 is placed beneath the summary profile 127. When pressed, the chat button 126 opens a chat window 250 wherein the two users may communicate in real time with each other. The flirts page 131 includes an approve button 132. The approve button 132 displays a flirts approval page 180.

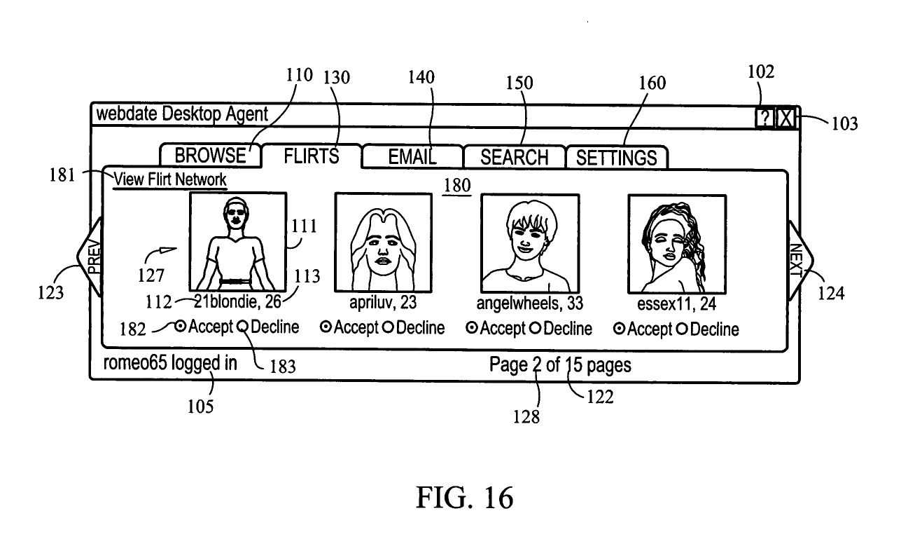

FIG. 16 shows the flirts approval page 180. The flirts approval page 180 shows summary profiles 127 of users who have sent flirts to the user. Each summary profile 127 includes a thumbnail 111, username 112, and an age 113. Beneath each summary profile 127 is an accept radio button 182 and a decline radio button 183. When the pending flirt requests have been accepted or declined by the user, the user may select a process button 184. When the process button 184 is selected the application sends information to the online dating database 400 to add the profile to the user's flirts list or to delete the profile from the user's pending flirt list. To replace the summary profiles 127 displayed on the pending flirts page 180, with additionally pending profiles, the user may select the previous page button 123 or next page button 124. To return to the flirts page 180, the user selects the view flirt network button 181.

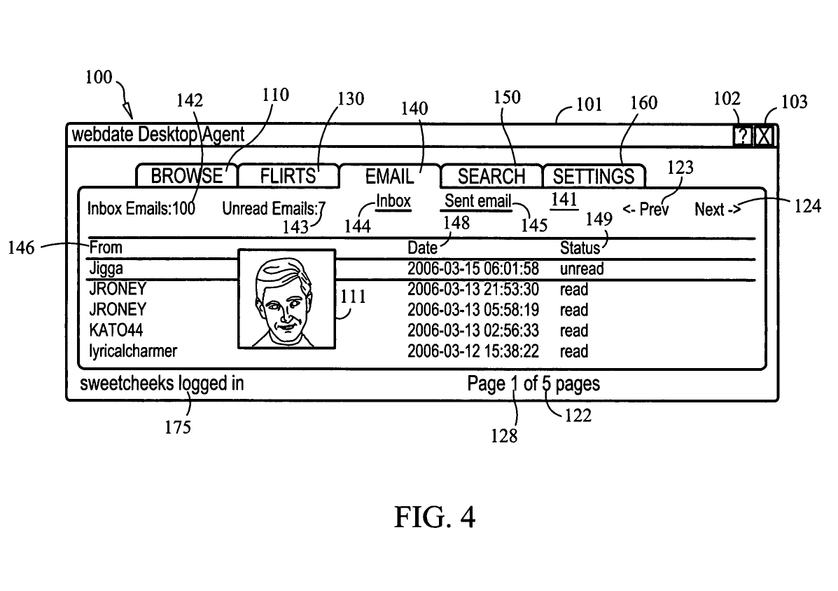

FIG. 4 shows the email page 141, which is on top within the window 100. The email page 141 displays a list of emails received by the user. The email page 141 includes a table with the following columns: from field 146, subject field 147, date sent field 148, and email status field 149. The from field 146 lists the username 112 who sent an email. The subject field 147 lists the subject of the email. The date sent field 148 lists the time and date when the email was sent. The email status field 149 lists the status of the message, i.e. read or unread. When the from field 146 of a given email is hovered over, a thumbnail 111 of the sender appears. Unread emails can be highlighted in a different color to help users identify unread messages. Selecting a message opens an email window 190 as shown in FIG. 11. The email window 190 has a title bar 101 and close button 103. For a selected message, the username who sent the email is displayed in the from field 146. The recipient username (i.e. the user's username) is displayed in the recipient username field 147. A message field 191 displays the text of the message. To reply to the email, the user clicks the reply button 192. Clicking the reply button opens an outgoing email window 210.

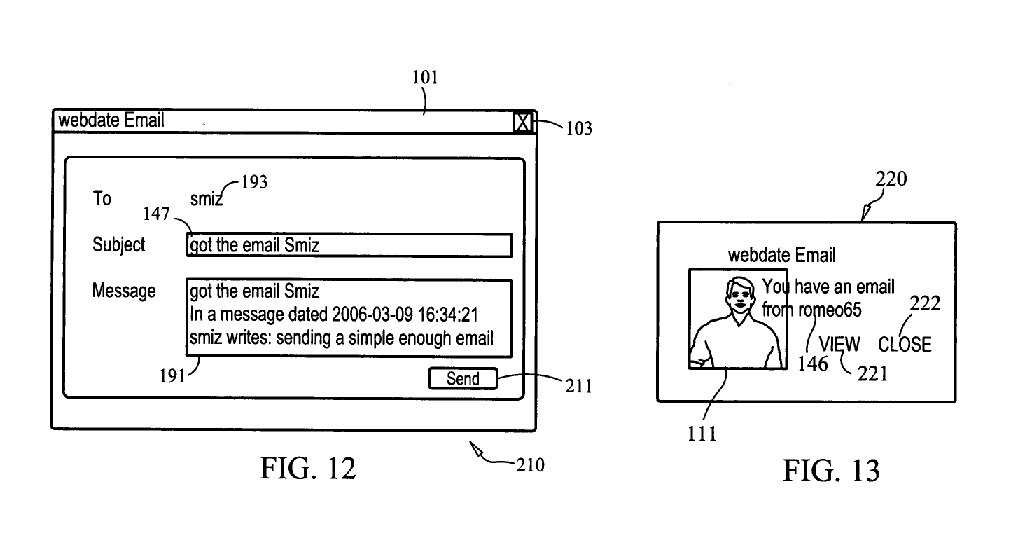

FIG. 12 shows the outgoing email window 210. A reply message can be sent by opening the outgoing email window 210. The recipient field 193 is automatically completed. A subject field 147 allows the user to enter a subject for the message. The user enters the body of a message in the message field 191. When completed, the user can select the send button 211 to send the message to the online dating database 400 where it is forwarded to the recipient user.

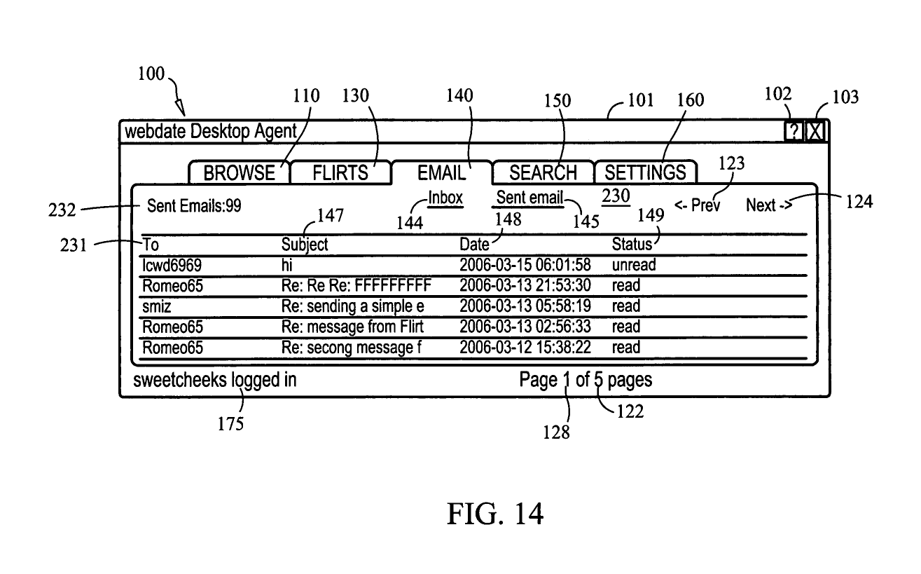

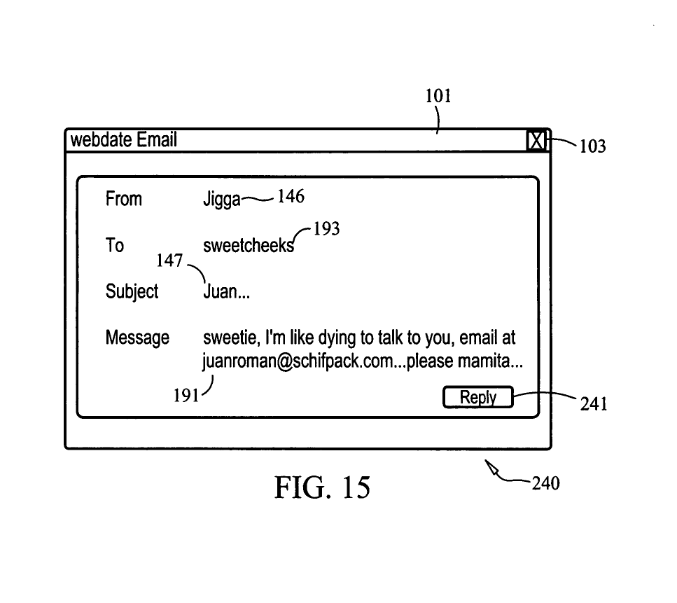

FIG. 14 shows a sent email page 230. The sent email page 230 is moved to the top of window 100 by selecting the sent email button 145. The sent emails are summarized in a table. The table has the following columns: a recipient field 231, a subject field 147, a date sent field 148, and a status field 149. The total email sent field 232 stores the number of emails that have been sent. When a message is selected, a sent email window 240 opens as shown in FIG. 15. The sent email window 240 includes a recipient filed 146 storing the username of the recipient, a sender field 193 storing the username of the sender, a subject field 147 storing the subject of the email message, and a message field 191 storing the text of the message. The sent email window 240 has a close button 241. When the close button 241 is selected, the sent email window 240 closes.

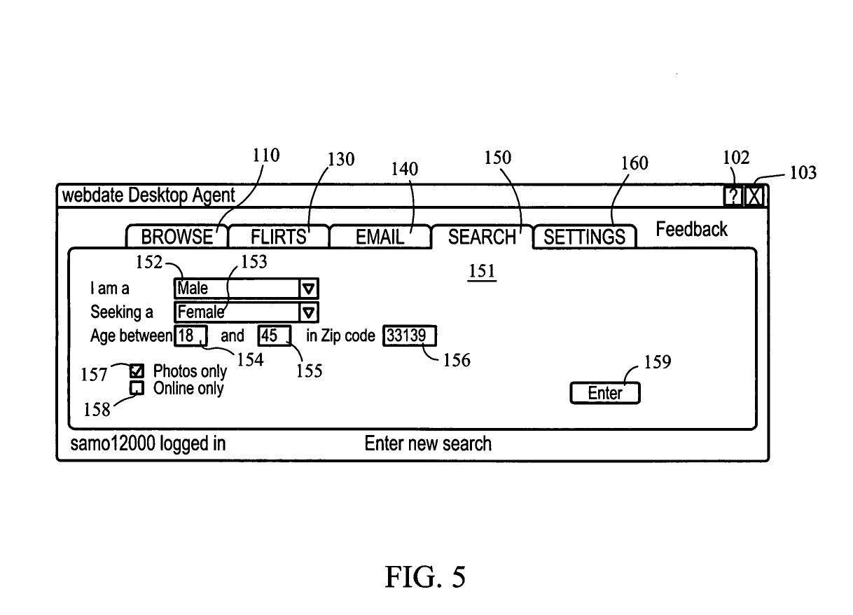

FIG. 5 shows the window 100 with the search page 151 on top. The search page 151 is moved to the top of the window 100 by selecting the search tab 150. The search page 151 is where a user enters criterion for searching the online dating database 400. The default criterion for the search are taken from the user's profile kept in the online dating database 400. As stated, profiles that match the criterion are displayed on the browse page 109. In the preferred embodiment, the search criteria that can be entered are the following fields: the user gender 152, the gender sought 153, the minimum age 154, the maximum age 155, the zip code 156. Additional filters can be added. For example, the results can be filtered to include only profiles that include photographs by checking the photo only checkbox 157. Likewise, the results can be filtered to include only profiles associated with users who are online by checking the online only checkbox 158. Once the criteria are entered, the user selects the enter button 159.

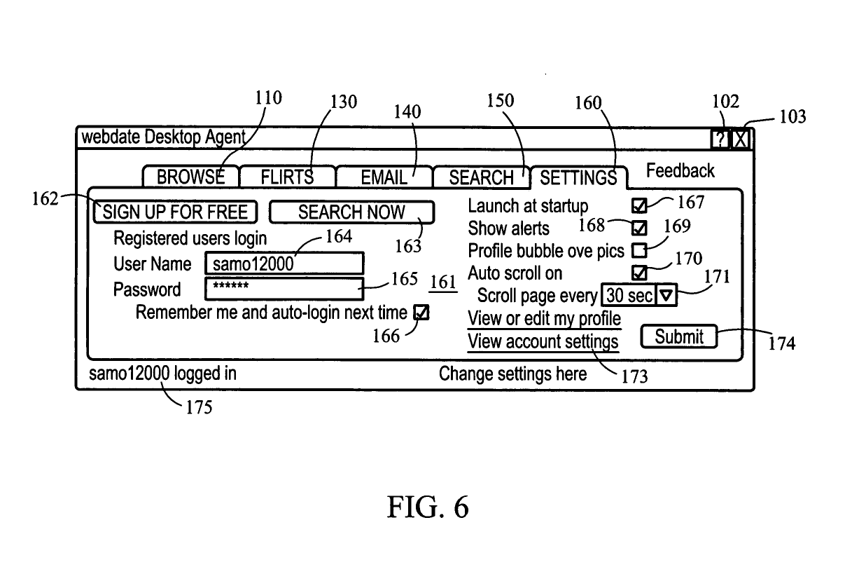

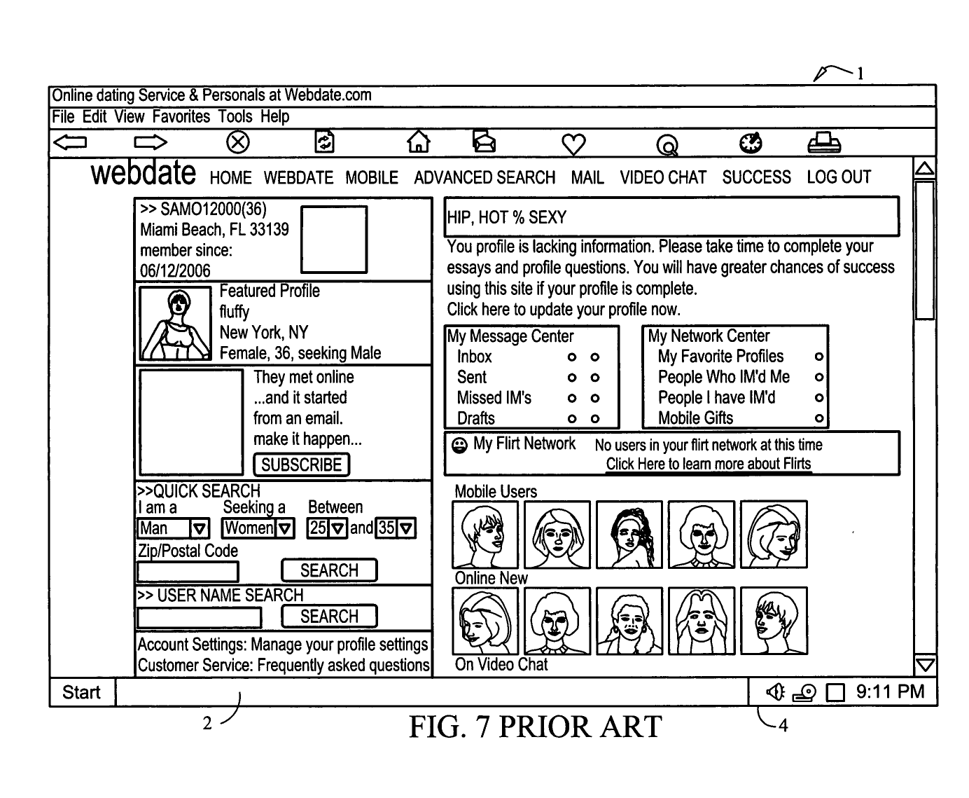

FIG. 6 shows the window 100 with a settings page 161 on top. To move the settings page 161 to the top of the window 100, the user selects the settings tab 160.

New users of the online dating database 400, who are installing the application for the first time, can create an account from the settings page 161. Selecting the signup button 162 opens a registration webpage of the online dating database 400.

Users with existing accounts with the online dating database 400 can login by entering their username and password into the username field 164 and password field 165, respectively. Checkboxes allow the user to change the settings of the application. The following are checkboxes included in the preferred embodiment: autologin checkbox 166, launch at startup 167, show alerts 168, profile bubble over pictures 169, and auto scrolling 170. A dropbox allows the user to set an autoscrolling time field 171. When the period of time specified in the autoscrolling time field 171 expires, the application replaces the summary profiles 127 in the browse page 109. When the autoscrolling checkbox 170 is unchecked, the browse page 109 is changed by pressing the previous page button 123 and the next page button 124.

Selecting the auto-login checkbox 166 causes the application to automatically login the user into the application without having to enter your username and password every time the application is launched. When a launch at startup checkbox 167 is checked, the application starts automatically whenever the workstation 403 is started.

A show alerts checkbox 168 can be checked to cause the application to create a pop-up alert 220. FIG. 13 shows a popup alert 220. When an email, instant message, or flirt message is forwarded to the application, a popup alert 220 opens. The popup alert 220 includes a from field 146, a view button 221, and a close button 222. Hovering over the from field 146 opens a thumbnail 111. Selecting the view button 221 opens the incoming email window 190 or chat window 250. Selecting the close button 222 dismisses the popup alert 220.

When a profile bubble over profile checkbox 169 is checked on the settings page 161 and a user subsequently is browsing summary profiles 127 on the browse page 125, a bubble 129 opens when the user hovers over a given profile as shown in FIG. 18. The bubble contains more information than the summary profile and allows the user to quickly determine if the user wishes to invite the member to become a match.

The settings page 161 has a view/edit profile button 172. Selecting the view/edit profile button 172 opens a webpage with which the user can view and/or edit the user's profile in the online dating database 400.

A view account settings button 173 is included on the settings page 161. A user changes account settings by selecting the view account settings button 173. The settings that can be changed include email address, zip code, and password.

A status field 175 is included on the settings page 161. The status field 175 describes the status of the application. Typically the status is “logged in” when a user has properly logged into the online dating database 400. The status field 175 displays error messages when the application is unable to login. After successfully logging in, the browse tab 110 becomes activated.

I claim:

1. A dedicated computer client application for interfacing with an online dating database of profiles, comprising:
a window displayed on a client computer desktop and covering only a portion of the computer desktop;
a summary profile from the online dating database being displayed in said window, said summary profile being derived from a profile of a member in the online dating database matching a criterion; and
a button disposed in said window and associated with said summary profile, said button inviting said member to add the user to a match list of the member and the user.

2. The application according to claim 1, wherein said window displays a plurality of summary profiles.

3. The application according to claim 1, wherein said summary profile is replaced with a further summary profile from the online dating database matching said criterion.

4. The application according to claim 1, wherein said summary profile is a potential match requiring approval to become a match.

5. The application according to claim 1, wherein:
said window includes a search page where said criterion is entered; and
said criterion is transmitted to the database.

6. The application according to claim 1, wherein said window remains on top of the computer desktop but allows a further application to be visible on the computer desktop.

7. The application according to claim 1, wherein said summary profile is XML data formed from the online dating database and displayed by the application.

8. The application according to claim 1, further comprising a further window displaying a detailed profile of said summary profile when said summary profile is selected.

9. The application according to claim 1, which further comprises an email button disposed in said window and associated with said summary profile, said email button opening an email window to write an email to a user associated with said summary profile.

10. The application according to claim 1, wherein said button is a flirt button.

11. The application according to claim 1, which further comprises a chat button disposed in said window and associated with said summary profile, said chat button being present when a user associated with said summary profile is online and opening a chat window with the user when clicked.

12. The application according to claim 1, wherein said summary profile includes a photograph.

13. The application according to claim 1, further comprising a next page button disposed in said window, next page button replacing said summary profile with a further summary profile matching the criterion.

14. The application according to claim 1, further comprising a flirt page in said window, said flirt page showing a summary profile of a member who has accepted a flirt request from a user.

15. The application according to claim 1, further comprising a flirt page in said window, said flirt page showing a summary profile of a member who has sent a flirt request to a user.

16. The application according to claim 15, further comprising an approve button to approve said flirt request.

17. The application according to claim 1, further comprising an email page in said window, said email page showing incoming email from members.

18. The application according to claim 17, further comprising an unread button, said unread button filtering said incoming email to show only unread incoming email.

19. The application according to claim 17, further comprising a sent email button, said email window displaying sent email when said sent email button is selected.

20. The application according to claim 1, further comprising a search page disposed in said window, said search page including a field for entering the criterion to be sent.

21. The application according to claim 1, wherein said criterion is a criterion selected from the group consisting of user sex, seeking sex, lowest age, highest age, zip code, photos only, and online only.

22. The application according to claim 1, further comprising a settings page disposed in said window, said settings page including a username field for entering a username, a password field for entering a password, and a submit button, said submit button transmitting the username and the password to the online dating database.

23. The application according to claim 1, further comprising a settings page including a button selected from the group consisting of a launch-at-startup button, a show alerts checkbox, and a profile bubble over pictures checkbox.

24. The application according to claim 1, further comprising a settings page including an autoscrolling checkbox for selecting when said summary profile should be replaced automatically.

25. The application according to claim 24, further comprising an autoscrolling time field on said settings page for setting a time period when said summary profile is replaced.

26. The application according to claim 25, further comprising an autoscrolling drop box displaying a time period when said summary profile is replaced, said time period being selected from five seconds, fifteen seconds, thirty seconds, forty-five seconds, and sixty seconds.
